(19) United States
(12) Patent Application Publication
(10) Pub. No.: US 2003/0122957 A1
(43) Pub. Date: Jul. 3, 2003

(54) Mobile terminal with digital camera and method of capturing images

(76) Inventor: Niels Peter Emme, Hellerup (DK)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/029,968

(22) Filed: Dec. 31, 2001

(51) Int. Cl. H04N 5/222; H04N 5/225

(52) U.S. Cl. 348/370; 348/373; 348/342; 455/556

(57) ABSTRACT

The invention relates to a mobile communication terminal provided with a digital camera and an infrared port. The digital camera and the infrared port are arranged such that the infrared light emitted by the infrared port can be used to capture images with infrared light.

### BACKGROUND OF THE INVENTION

1. Field of the Invention

The present invention relates to mobile communication terminals, in particular mobile communication terminals that comprise a source of infrared light, such as an infrared port and a digital camera.

2. Description of the Prior Art

U.S. Pat. No. 6,031,825 discloses a system for providing an infra red link between a mobile phone and its accessories. The mobile phone is provided with an infrared transceiver comprising an infrared receiver and an infrared LED. The infrared port provides for a wireless connection between the phone and its accessories, such as a personal computer, a printer, or another phone to transmit data, audio, control and logical signals between them.

Recently, mobile phones have been equipped with digital cameras. EP-A-0 898 405 discloses a mobile phone provided with a digital camera and an infrared port. The mobile phone has an upper case and a lower case connected by a connection part. The infrared port and the digital camera are both arranged in a connection part, facing opposite directions. The camera can capture images using visible light.

Charged Coupled Devices (CCDs) that are used in commercially available digital cameras are sensitive both to light in the visible spectrum and in the near infrared spectrum. These digital cameras are therefore provided with infrared filters so that interference by any infrared light entering the camera is avoided.

### SUMMARY OF THE INVENTION

The availability of infrared light and the inherent sensitivity of CCDs to infrared light offers an hereto unrealized potential to use communication terminals equipped with an infra red port and a digital camera to capture infrared images. On this background, the present invention provides a mobile phone of the kind, which can be used to capture infrared images. A mobile communication terminal in accordance with the invention comprises a digital camera having an angle of view, the mobile communication terminal further comprising a source of infrared light for emitting a beam of infrared light, whereby the angle of view and the infrared light beam are directed such that a substantial part of the angle of view is overlapped by the infrared light beam so that objects in the angle of view may be illuminated by the infrared light beam.

The source of infrared light may be movable so that the direction of the infrared light beam can be substantially aligned with the angle of view.

The mobile communication terminal may further comprise an infrared filter that can be moved in and out of the light path into the camera.

The mobile communication terminal may be provided with an infrared filter that has a first position in the light path and a second position out of the light path.

The mobile communication terminal may comprise electro mechanical or electronic means to move the infrared filter from the first position to ht esecond position and back.

The mobile communication terminal may comprise a display, for displaying images captured by the camera. The images captured by the camera may be refreshed at regular intervals.

In a preferred embodiment at least 60% of the viewing angle is overlapped by the infrared light beam, preferably at least 80% of the viewing angle is overlapped by the infrared light beam, and even more preferable at least 90% of the viewing angle is overlapped by the infrared light beam.

The mobile communication terminal may be provided with software for processing captured digital images.

The mobile communication terminal may comprise a focusing system which focuses the light coming into the camera, whereby the focusing system has a first setting adjusted to the characteristics of visual light and a second setting adjusted to the characteristics of infrared light.

The mobile communication terminal may comprise a lens cover, having a first position covering the lens of the camera and a second position exposing the lens, the mobile communication terminal preferably further comprising an actuator which actuates the lens cover from the first position to the second position and back.

The mobile communication terminal may comprise a handle having a first position associated with the first position of the lens cover, the handle having a second position associated with the second position of the lens cover and the first position of the infrared filter, and the handle having a third position associated with the second position of said infrared filter

The present invention further is a method for capturing infrared images with a mobile communication terminal equipped with a digital camera and an infrared port.

This method of capturing infrared images comprises the steps of,

providing a mobile communication terminal comprising a digital camera and an infrared port, and

illuminating objects to be captured with the infrared light emitted by the infrared port.

Preferably, the method further comprises the step of arranging the digital camera and the source of infra red light substantially in the same direction on the mobile communication terminal.

The method may further comprise the step of providing an infrared filter for use when capturing images with visible light, and comprising the step of removing the infrared filter from the light path into the camera when capturing infrared images.

When the camera comprises an auto focus system, the method may further comprise the step of adjusting the settings of the auto focus system to the characteristics of infrared light when capturing infrared images.

When the mobile communication terminal comprises a display, the method may further comprise the step of displaying images captured by the digital camera on the display.

The method may further comprise the step of capturing the images at short intervals thus, allowing the mobile communication terminal to be used as a night vision device.

Further objects, features, advantages and properties of the invention will become apparent from the detailed description.

### BRIEF DESCRIPTION OF THE DRAWINGS

In the following detailed portion of the present description, the invention will be explained in more detail with reference to the exemplary embodiments shown in the drawings, in which

FIG. 1 shows in a perspective view the front of an embodiment of a communication terminal according to the invention,

FIG. 2 shows in a perspective view the rear of an embodiment of a communication terminal according to the invention with the lens exposed,

FIG. 2a shows in a perspective view the rear of an embodiment of a communication terminal according to the invention with the lens covered, and

FIG. 3 shows an embodiment of a mechanism for controlling the position of a cover for the camera module and for controlling the position of an infrared filter.

### DETAILED DESCRIPTION OF THE PREFERRED EMBODIMENTS

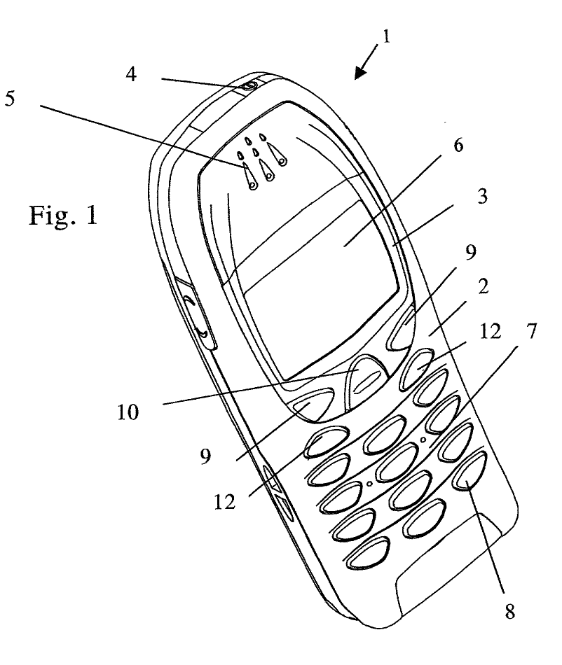

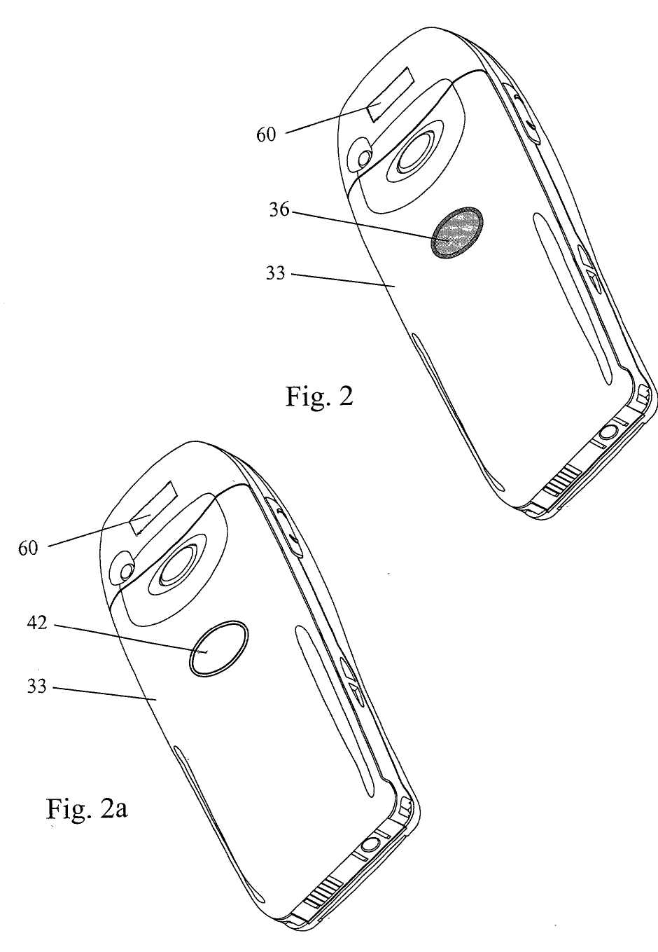

With reference to FIGS. 1 and 2 a mobile communication terminal according to the invention in the form of a hand portable phone 1, preferably a cellular! mobile phone, provided with a camera is described. The phone 1 is provided with a front cover 2 having a window frame 3 encircling the protection window of the display assembly. The phone comprises a user interface having an on/off button 4, a speaker 5 (only the openings are shown), a keypad 7, an LCD display 6 and a microphone (not shown). The LCD display may be a high resolution TFT matrix display for displaying high-resolution color pictures. The phone I further comprises a battery pack 11. The keypad comprises a first group of alphanumeric keys 8, two multi-function keys 9 (so-called soft keys), two call handling keys 12, and a scroll key 19. The functionality of the keys and the user interface is well known and not explained in detail here.

The mobile phone is provided with an infrared port 60. The infrared port is as such conventional and therefore not all features described here are shown in the drawings. The infrared port comprises a cover 60 that is transparent to infrared light. An infrared transceiver is arranged under the cover 60. Commercially available infrared transceivers may be used in this application. The infrared transceiver comprises a source of infrared light in the form of an infrared LED (not shown).

The LED emits a beam of infrared light through the cover 60 in a direction that is substantially perpendicular to the rear surface 33 of the mobile phone. The infrared port provides for a wireless connection between the phone I and its accessories, such as a personal computer, a printer, or another phone to transmit data, audio, control and logical signals between them. The general term “infrared light” as used here includes light with a wavelength of 770 to 1000 μm. Infrared transceivers as used for infrared ports on mobile phones operate typically with a wavelength of 850-900 μm.

The camera in the mobile phone is a conventional digital camera and therefore not all the features of the camera are shown. The camera uses one or more Charge Coupled Devices (CCDs) (not shown) for capturing images. The camera is further provided with a lens 36 and an auto focus system (not shown). A lens cover 42 protects the lens 36 and the camera from dust, direct sunlight and mechanical contact when the camera is turned off. The lens cover 42 is a slide cover that makes a sliding movement between a camera non-operating position, in which it covers at least the lens 36 and a camera operating position at which the lens is exposed. The camera is arranged at the rear of the mobile phone in the battery pack 11. The camera direction is therefore substantially perpendicular the to the rear surface 33 of the mobile phone 1. The camera has thus an angle of view directed away from the rear surface 33 of the mobile phone 1.

Standard CCD devices are sensitive to both visual light and near infrared light. Conventional digital cameras for capturing images with visual light are therefore provided with an infrared filter for preventing influences of infrared light on the captured image. The mobile phone I is also provided with an infrared filter 43. The infrared filter 43 can though be moved out of the path of the light into the camera for capturing infrared images.

The lens 36 is preferably a fixed focal length lens with a movable lens group to allow auto focus, however, lens 36 could be any plurality of lens providing for adjustment to focus on different parts of the image received, as will be understood to those skilled in the art. The characteristics of visible light and near infrared light with respect to focusing are slightly different. Therefore, the auto focus system has two settings; a first setting for capturing images with visual light and a second setting for infrared light.

A standard software for processing, storing and recalling pictures captured with visual light and captured with infrared light is installed on the phone 1. This software may as such be conventional and commercially available. The software is also able to control the refresh rate of the images shown on the display and the refresh rate of the captured images.

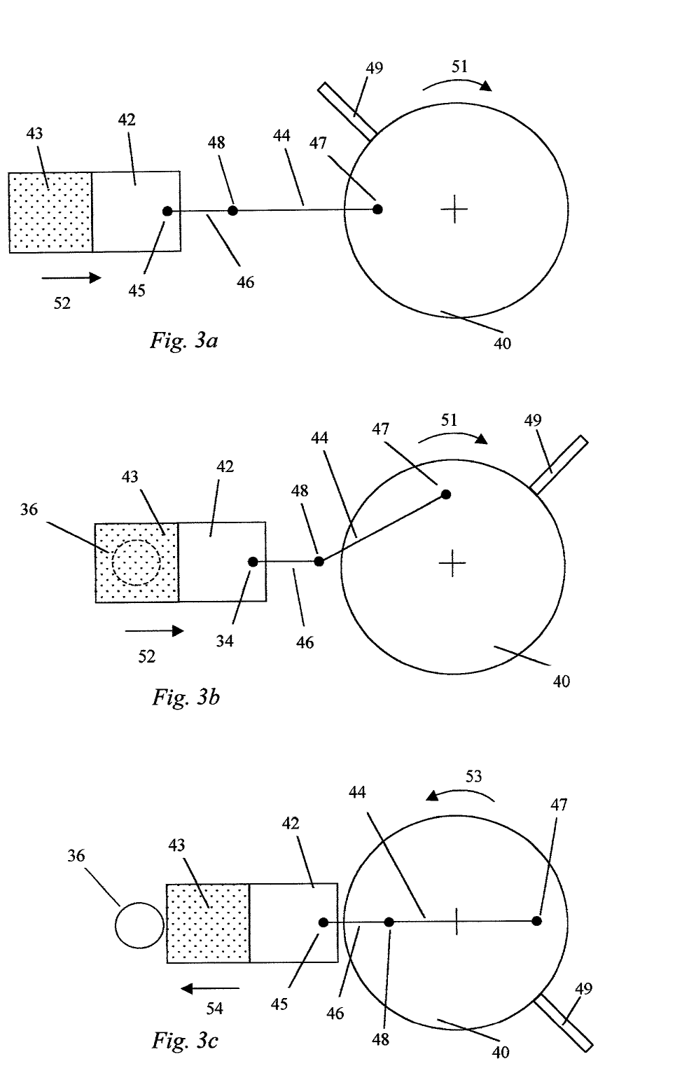

A mechanism for moving the lens cover 42 is described with reference to FIGS. 3a to 3c. The mechanism comprises a wheel 40, a lens cover 42 and a connection between the wheel 40 and the lens cover 42. The connection consists of a first link 46 and a second link 44 being connected in a joint 48. The first link 46 is attached to the lens cover 42 via a pivot point 45. The first link 47 is connected to the wheel 40 by a pivot point 47. The mechanism can move the lens cover 42 from a first, closed position to a second position and vice versa. An infrared filter 43 is connected to the lens cover 42 and moves integrally with the lens cover 42. In the second position of the lens cover 42, the infrared filter 43 is in the path of the light falling into the camera (FIG. 3b). There could of course be only one link or more than two links in the connection between the cover 42 and the wheel 40. The described mechanism has been simplified in that it does not include bearing, guiding elements, etc. to just show the essential parts of the mechanism. The wheel may be driven by an electrical actuator such as an electric motor or an electromagnetic actuator (not shown) or by a mechanical actuator such as a handle 49. As the wheel 40 is rotated, the link mechanism 45,46, will translate the rotating motion of the wheel 40 into a linear motion 53 of the lens cover 42 and the infrared filter 43. In FIG. 3a, the lens cover is in its first position where it covers and protects the camera lens 36 (not shown in FIG. 3a). The infrared filter 43 is in a parked position where it has no direct function. To move the lens cover 42 from its closed position, to its second position, and the infrared filter 43 from its parked position to its first position, the position in which the infrared filter 43 is in the light path into the camera, the wheel 40 is rotated in a clockwise direction 51 to move the pivot point 47 substantially above the center of the wheel as shown in FIG. 3b. When the lens cover 42 is moved to its second position, the open position, and the infrared filter 43 is moved to its first position, the camera lens 36 is exposed to the visible light, and the camera can be used to capture images with visible light. To move the lens cover back to its first position, the wheel 40 is rotated anticlockwise (not shown).

To move the infrared filter 43 to its second position, where it is not in the light path into the camera, the wheel 40 is rotated further in a clockwise direction 51 to move the pivot point 47 to be located to the right from the center of rotation as shown in FIG. 3c. The lens cover 42 is now in its third position, which is also an open position, and the infrared filter is in its second position, in which it is not in the light path into the camera. The lens is now also exposed to infrared light, and can be used to capture images with infrared light. In this position of the infrared filter, the infrared LED of the infrared port can be activated. The angle of view of the camera and the light beam emitted by the infrared LED are aimed in substantially the same direction. There is thus a substantial overlap of the angle of view and the infrared light beam so that objects in the angle of view of the camera are illuminated by the infrared light beam.

The infrared light beam overlaps preferably more than 60% of the angle of view and even more preferable more than 80% of the angle of view is overlapped by the infrared light beam. Thus, when the camera is aimed at an object to be photographed, the light emitted by the infrared LED is also directed to the object to be photographed which is illuminated with infrared light to enhance light intensity at which infrared images are captured.

In another embodiment (not shown) the infrared port may also be arranged movable with respect to the mobile phone I. Thus, the direction of the light beam emitted by the infrared LED can be directed towards an object to be illuminated.

The camera may be provided with further filters (not shown) such as ultraviolet filters, optical low and high pass filters of various wavelengths of visible light as known to those skilled in the art. Those skilled in the art will realize other filter may be used. The image sensor may comprise any of the known configurations for solid-state image sensors, such as frame transfer, interline transfer CCDs, or diode arrays

The captured images are shown on the display 6. In one mode of the mobile phone I stored images are displayed, whereas the images refreshed at a regular refresh rate are displayed in a second mode of the camera. When capturing infrared images in the second mode the mobile phone I may be used as a night vision device.

Although one single actuating mechanism for controlling the lens cover and the infrared filter has been shown, it is possible to use a first mechanism for the lens cover and another mechanism for the infrared filter. The shown mechanism is mechanical. Other actuating mechanisms for controlling the position of the lens cover are of course also within the scope of the invention. Such mechanisms can be electro-mechanical, or electronic or other actuating devices generally used in camera technology. The camera has been shown as arranged in the battery pack 11 of the mobile phone, but it is understood that the camera could be arranged in other places in the mobile phone. The same applies to the location of the infrared port, as long as the view angle of the camera and the light beam of the infrared port can have a substantial overlap.

1. Mobile communication terminal comprising a digital camera having an angle of view, said mobile communication terminal further comprising a source of infrared light for emitting a beam of infrared light, whereby said angle of view and said infrared light beam are directed such that a substantial part of said angle of view is overlapped by said infrared light beam so that objects in said angle of view may be illuminated by said infrared light beam.

2. Mobile communication terminal according to claim 1, wherein said source of infrared light is movable and the direction of said infrared light beam can be substantially aligned with said angle of view.

3. Mobile communication terminal according to claim 1 or 2, further comprising an infrared filter that can be moved in and out of the light path into said camera.

4. Mobile communication terminal according to claim 3, wherein said infrared filter has a first position in said light path and a second position out of said light path.

5. Mobile communication terminal according to claim 4, characterized by comprising electro-mechanical or electronic means to move said infrared filter from said first position to said second position and back.

6. Mobile communication terminal according to any of claims 1 to 5, characterized by comprising a display, for displaying the image captured by said camera.

7. Mobile communication terminal according to any of claims 1 to 6, wherein said image captured by said camera is refreshed at regular intervals.

8. Mobile communication terminal according to any of claims 1 to 7, wherein at least 60% of said viewing angle is overlapped by said infrared light beam, preferably at least 80% of said viewing angle is overlapped by said infrared light beam, and even more preferable at least 90% of said viewing angle is overlapped by said infrared light beam.

9. Mobile communication terminal according to any of claims 1 to 8, wherein said camera is provided with software for processing captured digital images.

10. Mobile communication terminal according to any of claims 1 to 9, comprising means for focusing the light coming into said camera, whereby said means for focusing have a first setting adjusted to the characteristics of visual light and a second setting adjusted to the characteristics of infrared light.

11. Mobile communication terminal according to any of claims 1 to 10, comprising a lens cover, having a first position covering the lens of said camera and a second position exposing said lens, said mobile communication terminal preferably further comprising means for actuating said lens cover from said first position to said second position and back.

12. Mobile communication terminal according to claim 11, comprising a handle having a first position associated with said first position of said lens cover, said handle having a second position associated with said second position of said lens cover and said first position of said infrared filter, and said handle having a third position associated with said second position of said infrared filter.

13. Method of capturing infrared images comprising the steps of,
providing a mobile communication terminal comprising a digital camera and an infrared port, and
illuminating objects to be captured with infrared light emitted by said infrared port.

14. Method according to claim 13, further comprising the step of arranging said digital camera and said source of infrared light in substantially in the same direction on said mobile communication terminal.

15. Method according to claim 13 or 14, further comprising the steps of,
providing an infrared filter for use when capturing images with visible light, and
removing said infrared filter from the light path into the camera when capturing infrared images.

16. Method according to any of claims 13 to 15, wherein said camera comprises an auto focus system, further comprising the step of adjusting the settings of said auto focus system to the characteristics of infrared light when capturing infrared images.

17. Method according to any of claims 13 to 16, wherein said mobile communication terminal comprises a display, further comprising the step of displaying images captured by said digital camera on said display.

18. Method according to any of claims 17 above, further comprising the step of capturing and displaying said images at short intervals, thus allowing the mobile communication terminal to be used as a night vision device.
